(19) United States
(12) Patent Application Publication
(10) Pub. No.: US 2009/0086289 A1
(43) Pub. Date: Apr. 2, 2009

(54) IMAGE READING DEVICE

(75) Inventor: Shohei TSUJIMOTO, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/235,964

(22) Filed: Sep. 23, 2008

(30) Foreign Application Priority Data
Oct. 2, 2007 (JP) 2007-258897

(51) Int. Cl. H04N 1/04

(52) U.S. Cl. 358/498

(57) ABSTRACT

An image reading device is provided. The image reading device includes an automatic feeder unit to feed original sheets one by one, an image reading unit to read an image formed on each of the original sheets being fed, and a file creation unit to create a data file for a set of the image and store the created data file in a predetermined storage unit. When a plurality of sheet sets, respectively including at least one original sheet, are placed in the automatic feeder unit to be fed successively and when a criterial feature to distinguish a current sheet set from a succeeding sheet set is detected, the file creation unit completes the data file for the image which has been read from the current sheet set by the image reading unit and starts creating a new data file for the succeeding sheet set.

### CROSS REFERENCE TO RELATED APPLICATION

This application claims priority from Japanese Patent Application No. 2007-258897, filed on Oct. 2, 2007, the entire subject matter of which is incorporated herein by reference.

### BACKGROUND

1. Technical Field

An aspect of the present invention relates to an image reading unit to read an image on an original document which is fed by an automatic feeder unit, specifically to an image reading unit to collectively read a plurality of separate sets of original documents.

2. Related Art

An image reading device such as a multifunction peripheral device having a scanning unit is often provided in an office building to be used by a group of people. In such an environment, for example, an image forming apparatus, which can be operated process a plurality of jobs according to a predetermined priority order, is suggested in Japanese Patent Provisional Publication No. 2000-134391. According to the publication, the priority order of a job is determined based on a combination of functional units (i.e., an image reading unit, a data communication unit, a facsimile transmission unit, and an image memory unit) to be used to execute the job. Thus, an operation to form an image and/or data transmission for an image can be performed while an original document is read by the image reading unit. For example, when a job to use a copier function and a job to use a printing function to print an image received through the data communication unit are respectively required to be processed, the image forming unit is preferentially occupied by the copier job, and the image data for the printing job is temporarily stored in the image memory unit to wait for the copier job to be completed.

Even in the above configuration, however, when a plurality of users intend to use the image forming apparatus to scan original documents to create electronic files simultaneously, a reading operation is required for each of the users' documents. Therefore, for example, when the image forming apparatus is occupied to scan a large volume of an original document, succeeding users are required to wait until the scanning operation for the large volume of document is completed. The succeeding users may leave the image forming apparatus temporarily until the preceding scanning operation completes. However, when they return to the image forming apparatus after a substantial period of time, the users may find another new user is occupying the image forming apparatus.

### SUMMARY

In consideration of the above, an image reading device capable of being operated without keeping a user to wait for completion of a preceding reading operation is desired. Therefore, an image reading device to collectively read a plurality of sets of original documents is provided.

According to an aspect of the present invention, the present invention is advantageous in that an image reading device is provided. The image reading device includes an automatic feeder unit to feed original sheets one by one, an image reading unit to read an image formed on each of the original sheets being fed, and a file creation unit to create a data file for a set of the image read by the image reading unit and store the created data file in a predetermined storage unit. When a plurality of sets of original sheet are placed in the automatic feeder unit to be fed successively and when a criterial feature to distinguish a succeeding set of original sheet from a preceding set of original sheet is detected between two successive sets of the original sheet, the file creation unit completes the data file for the image which has been read from the preceding set of original sheet by the image reading unit and starts creating a new data file for the succeeding set of original sheet.

According to the above configuration, a plurality of sets of original sheets can be read collectively, and a plurality of data files can be created distinctively for images formed on respective sets of original sheets. Therefore, users may use the image reading device without waiting for completion of a reading operation to read a preceding set of original documents.

### BRIEF DESCRIPTION OF THE ACCOMPANYING DRAWINGS

FIG. 1 illustrates a perspective view of an image reading device according to an embodiment of the present invention.

FIG. 2 is a block diagram to illustrate an electronic configuration of the image reading device according to the embodiment of the present invention.

FIG. 3 is a flowchart to illustrate an image reading operation according to a first embodiment of the present invention.

FIG. 4 illustrates a plurality of sets of original documents to be read by the image reading device according the embodiment of the present invention.

FIG. 5 is a flowchart to illustrate an image reading operation according to a second embodiment of the present invention.

FIG. 6 is a flowchart to illustrate an image reading operation according to a third embodiment of the present invention.

FIG. 7 is a diagram to schematically illustrate an image reading device with a plurality of feeding trays according to the third embodiment of the present invention

### DETAILED DESCRIPTION

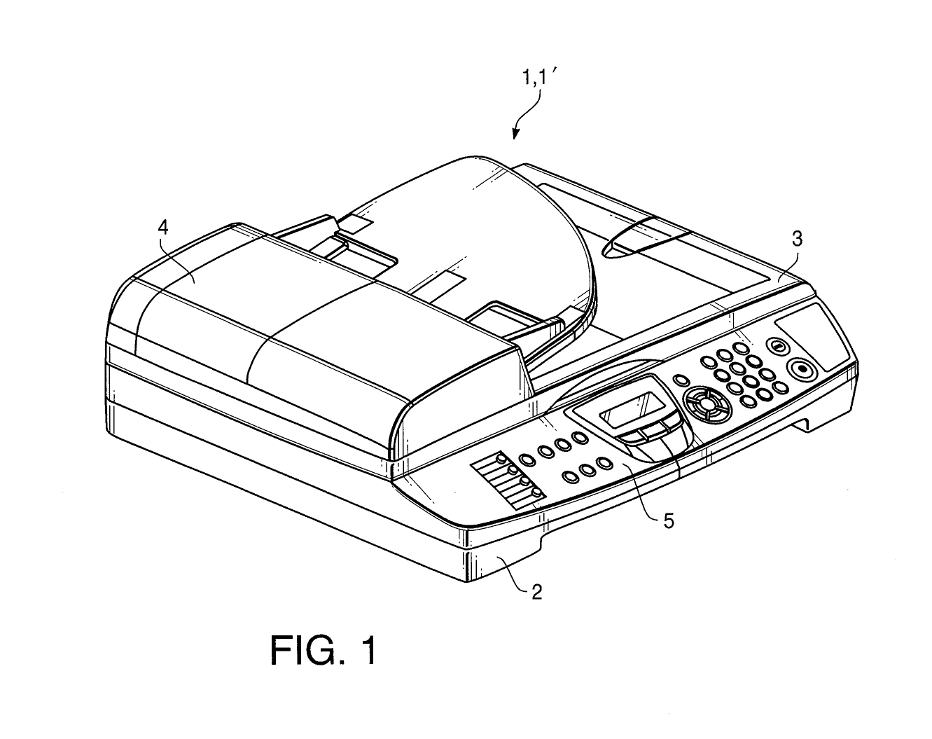

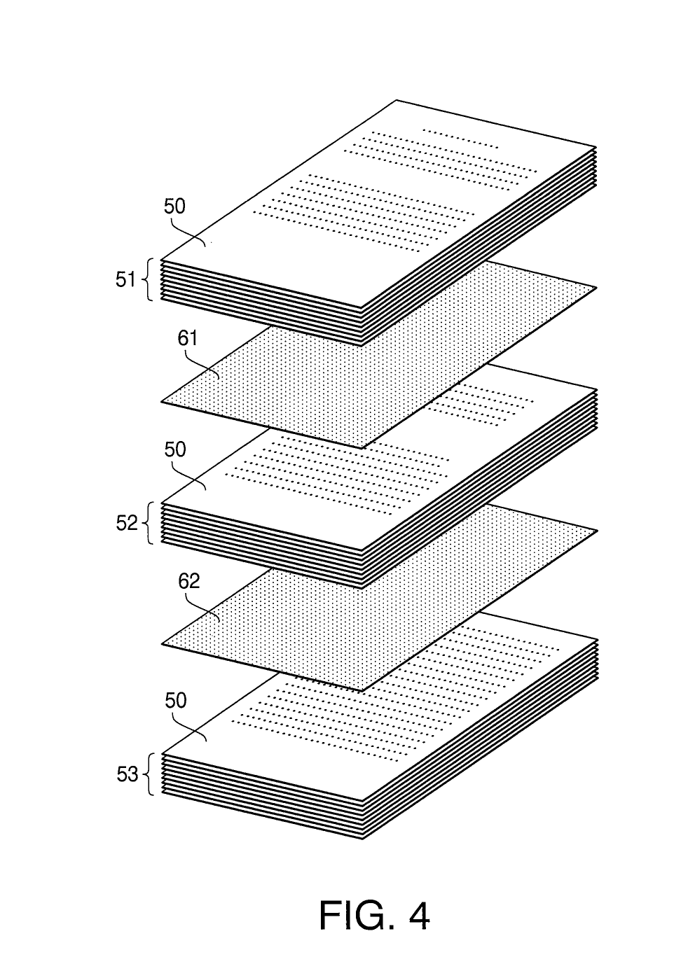

Hereinafter, embodiments according to aspects of the present invention will be described with reference to the accompanying drawings. FIG. 1 illustrates a perspective view of an image reading device 1 according to an embodiment of the present invention. The image reading device 1 according to the embodiment of the present invention is a scanner unit of a so-called flatbed type having a body 2 at a bottom and a cover 3 placed over the body 2. The cover 3 is pivotably opened and closed about a shaft (not shown). The image reading device 1 is configured to have a document reader panel (not shown) to read an image formed on an original document on top of the body 2. The original document with the image to be read can be placed on the document reader panel by the user who opens the cover 3. Alternatively, the original document can be read when the original document is fed by an automatic feeder unit 4. In either way, an operation to read the image is conducted when the original document is set in place with a correct side (i.e., a surface on which the image is formed) facing upward. When the automatic feeder unit 4 is used, the original documents are set in the automatic feeder unit 4 in an arrangement as shown in FIG. 4. FIG. 4 illustrates a plurality of sets of original documents 51-53 to be read by the image reading device 1 according the embodiment of the present invention. As the automatic feeder unit 4 starts feeding, a lowermost sheet 50 in a lowermost set of original documents 53 is fed. When the lowermost sheet 50 is fed, a next lowermost sheet 50 succeeds to be fed. The sheets 50 having been red are automatically discharged out of the automatic feeder unit 4.

The above-described automatic feeder unit 4 is provided to the cover 3. Further, the image reading device 1 is provided with an operation/display unit 5, having various switches to operate the image reading device 1 and a liquid crystal display to present various information concerning the image reading device 1 to a user, to the body 2.

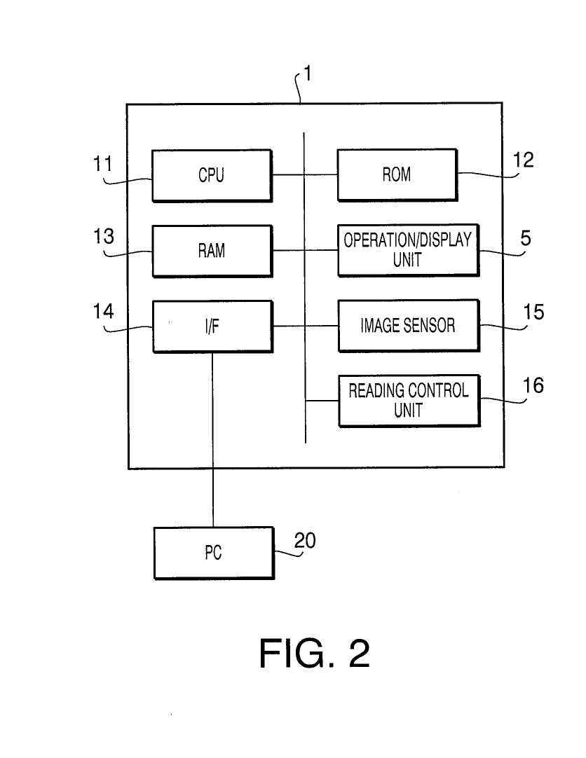

FIG. 2 is a block diagram to illustrate an electronic configuration of the image reading device 1 according to the embodiment of the present invention. The image reading device 1 includes a CPU 11 to control entire operations in the image reading device 1, a ROM 12 to store various programs to be executed by the CPU 11, and a RAM to store various information concerning the programs. The image reading device 1 further includes the operation/display unit 5 and an I/F (interface) unit 14, through which the image reading device 1 is connected with an external device (e.g., a PC 20).

Furthermore, the image reading device 1 is provided with an image sensor 15. The image sensor 15 is arranged in the body 2 and shifted along the document reader panel during the reading operation when the original document is placed on the document reader panel. Alternatively, when the original document is fed by the automatic feeder unit 4, the image sensor 15 is fixed during the reading operation in a predetermined reading position. In either way, as the original document is illuminated, the image sensor 15 receives the light reflected on the surface of the original document. Image signals received by the image sensor 15 are passed to a reading control unit 16, which drives the image sensor 15 and the automatic feeder unit 4. The image signals received by the image sensor 15 are passed to the reading control unit 16.

The image signals passed to the reading control unit 16 are converted into digital image data and preferably corrected (e.g., shading correction). The corrected image data is temporarily stored in the RAM 13 and transmitted to the external device (e.g., the PC 20) through the I/F unit 14 according to control of the CPU 11. The image data is stored in a storage unit (e.g., an HDD) in the PC 20. Optionally, the image data can be stored in an additional storage unit which is not shown in FIG. 2.

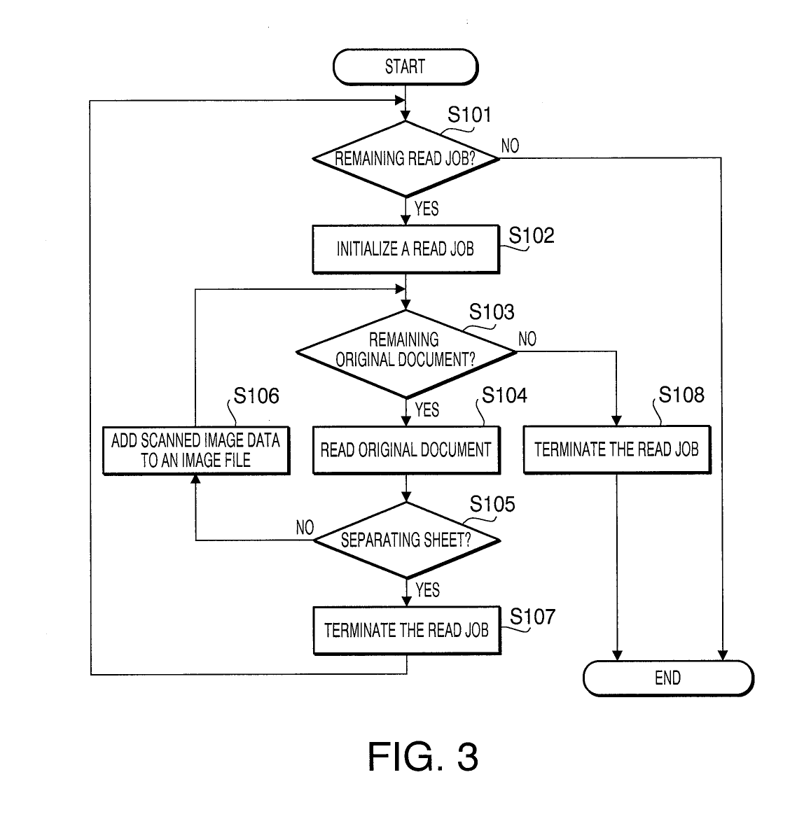

In the above configuration, specifically when the automatic feeder unit 4 is used, a plurality of sheets 50 of original documents can be collectively read. In the image reading device 1, a plurality of separate sets of original documents 51-53 can be collectively read according to a program for collective reading. FIG. 3 is a flowchart to illustrate an image reading operation according to the program for collective reading in a first embodiment of the present invention.

When the plurality of sets of original documents 51-53 are read, in a conventional image reading device, the sets of original documents 51-53 are processed to be read one by one. I.e., when a reading operation to read a first original document 53 is completed, a second original document 52 is set in the automatic feeder unit 4, and a read start button (not shown) to initiate the reading operation is pressed for a new reading operation. However, according to the present invention, while the sheets 50 in the original document 53 in the automatic feeder unit 4 are fed to be read, another set of original document 52 can be set on top of the original document 53. A user who operated the image reading device I to read the original document 53 (a first user) and a user who sets the original document 52 on top of the original document 53 (a second user) may be different. It is to be noted that, prior to setting the original document 52 on top of the original document 53, the second user is required to place a predetermined format of separating sheet 62 between the original documents 53 and 52 (i.e., on top of the original document 53 and below the original document 52). Further, a third user can place a separating sheet 61 on top of the original document 52 and additional original document 51 on the separating sheet 61. The separating sheets 61, 62 may be, for example, solid black or white sheets of paper which are recognized to be distinctive from the original documents 51-53. In the present embodiment, the separating sheets 61, 62 are sheets of paper having dots entirely over the surfaces.

When the original documents 51-53 are set in the automatic feeder unit 4 with the separating sheets 61, 62 in between, and the read start button is operated, the image reading operation starts in the image reading device 1. In S101, it is examined as to whether a read job remains unprocessed. Specifically, in the present embodiment, when an original document is placed in the automatic feeder unit 4, it is judged that a read job remains (S101: YES). In S102, the read job is initialized. A process in S102 will be described later in detail.

In S103, it is examined as to whether at least one sheet of an original document is placed in the automatic feeder unit 4. In S103, presence of an original document is judged by a sensor (not shown) equipped in the automatic feeder unit 4. If a sheet is detected (S103: YES), in S104, the automatic feeder unit 4 feeds the sheets 50 one by one, and each sheet 50 is read by the image sensor 15. In the present embodiment, the sheets 50 in the original documents 53, 52, 51 are fed in the order given. Specifically, in each original document, the sheets 50 are fed in an order from bottom to top. I.e., the lowermost sheet 50 is fed first, and a next lowermost sheet 50 succeeds to be fed. When the entire sheets 50 in the original document 53 are fed, the separating sheet 62 is fed. As a sheet is fed, in S105, it is examined as to whether the sheet currently being fed is a separating sheet. I.e., it is examined as to whether the entire sheets 50 in the original document 53 are fed.

In S105, if the sheet being fed is not a separating sheet (S105: NO), in S106, the image data obtained by the image sensor 15 is added to an image data file for the original document 53, which is stored in the RAM 13. The process returns to S103 to examine as to whether a sheet 50 remains, and the steps S104, S105, S106 are repeated until the entire sheets 50 in the original document 53 are read.

When the separating sheet 62 is fed, and in S105, if it is judged that the sheet being fed is a separating sheet (S105: YES), in S107, a terminating process for the read job is executed. Specifically, the image data file for the original document 53 is completed and transmitted to be stored in a predetermined folder in the HDD of the PC 20. Thereafter, the process returns to S101, and if a remaining read job is detected (S101: YES), the process repeats S102 to create a new image data file for the next original document 52.

The steps following S102 are similarly executed for the original document 52 until the separating sheet 61 is found in S105. When the separating sheet 61 is detected (S105: YES), in S107, the image data file for the original document 52 is completed and transmitted to the PC 20 to be stored.

The process returns to S102, and the original document 51 is processed similarly. In the original document 51, however, when a topmost sheet 50 is read (S104, S105: NO), and the image data is added to the image data file for the original document 51 (S106), no remaining sheet is detected in the automatic feeder unit 4 (S103: NO). Accordingly, in S108, the terminating process for the read job is executed. In S103, if a separating sheet is set on top of the original document 53 (S103: YES), in S104, the separating sheet is read. Thereafter, in S105, it is judged that the sheet is a separating sheet (S105: YES), in S107, the terminating process for the read job is executed. The process returns to S101, and no remaining sheet detected in the automatic feeder unit 4; therefore, it is judged that no read job remains (S101: NO). The process is terminated thereafter.

According to the image reading device 1 in the present embodiment, a plurality of sets of the original documents 51-53 can be collectively read, and an image data file for each original document can be created. Therefore, succeeding users may not be required to wait for the image reading device 1 to finish reading an original document of a preceding user so that the image reading operations for the plurality of sets of original documents can be executed efficiently. In this configuration, an order to read the stack of sheets 50 can be from top to bottom, i.e., a topmost sheet 50 is read first, and a next topmost sheet 50 succeeds thereafter.

In the above embodiment, the reading operations for the original documents 52, 51 are added while the original document 53 is in progress to be read. However, the original documents 53, 52, 51 with the separating sheets 62, 61 in between can be prepared before the reading operation for the original document 53 starts. In this setting, the image data files for the original documents 53, 52, 51 can be separately created. I.e., one user may create the image data files for the plurality of sets of original documents.

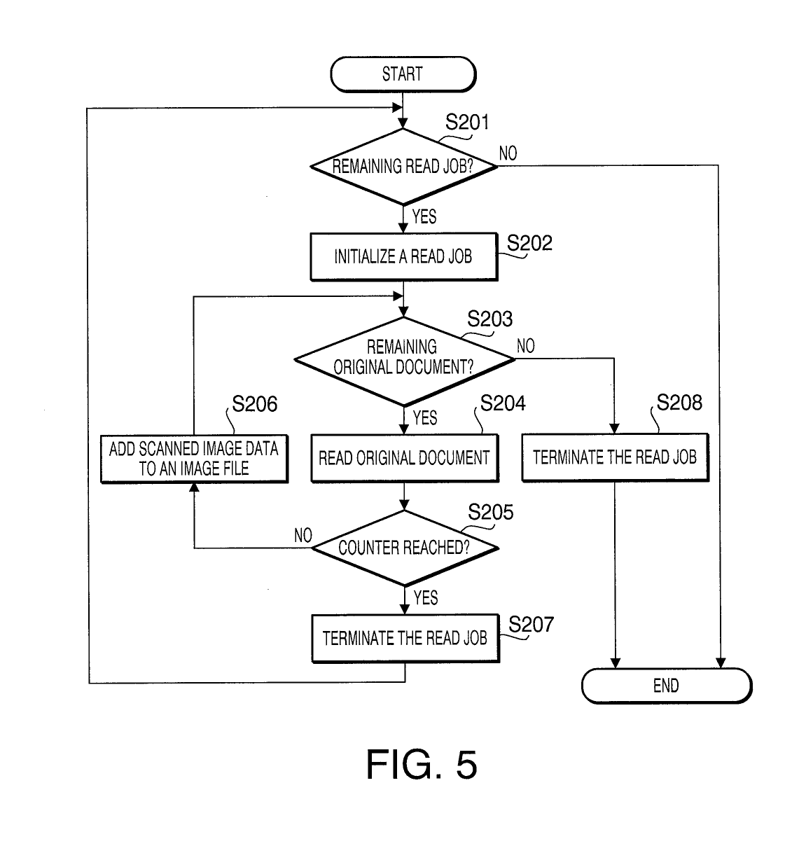

Next, a second embodiment of the present invention will be described. FIG. 5 is a flowchart to illustrate the image reading operation according to a second embodiment of the present invention. An image reading device 1′ (see FIG. 1) with a program for collective reading installed is configured similarly to the image reading device 1 in the previous embodiment. Specifically, however, the image reading device 1′ is provided with numerical keys (not shown) in the operation/display unit 5 through which a user can enter a number of sheets 50 of each original document 51, 52, 53. With the numerical keys, when the plurality of sets of original documents 51, 52, 53 are collectively read in the order given, the user enters the number of sheets 50 of the original documents 51, 52, 53. In the present embodiment, a topmost sheet 50 is read first, and a next topmost sheet 50 succeeds thereafter.

According to the present embodiment, the separating sheets 61, 62 are not included in between the original documents 51, 52, 53. With a stack of the original documents 51, 52, 53 set in the automatic feeder unit 4, the user is required enter a number of the original documents (i.e., 3) and numbers of sheets 50 included in the original document 51, 52, 53 respectively. For example, when the user enters “3” indicating the number of the original documents 51, 52, 53, a screen to prompt the user to enter the numbers of the sheets 50 in the three original documents 51, 52, 53 is presented in the liquid crystal display of the operation/display. In the present embodiment, it is assumed that the original document 51 includes eight sheets, the original document 52 includes seven sheets, and the original document 53 includes six sheets. Therefore, the user enters 8, 7, 6 for the respective original documents 51, 52, 53 through the numerical keys. Thereafter, when the read start button is operated, the reading operations in cooperation with the automatic feeder unit 4 are executed.

Further, the image reading device 1′ has a counter (not shown) in the RAM 13 to count a number of sheets 50 which have been read by the image sensor 15 in a reading operation for each original document. The counter is initialized to 0 when the reading operation for each original document is completed and increased by one each time a sheet 50 in the original document is read by the image sensor 15.

When the read start button is operated, the image reading operation starts in the image reading device 1′. In S201, it is examined as to whether a read job remains unprocessed. Specifically, in the present embodiment, the numbers 8, 7, 6 entered to indicate the numbers of the sheets 50 included in the original documents 51, 52, 53 are counted, and it is examined as to whether the jobs corresponding to the original documents 51, 52, 53 are completed. If one or more read jobs remain (S201: YES), In S202, the read job is initialized, and image data for the remaining read job is created.

In S203, it is examined as to whether at least one sheet of an original document is placed in the automatic feeder unit 4. If a sheet is detected (S203: YES), in S204, the automatic feeder unit 4 feeds the sheets 50 one by one, and each sheet 50 is read by the image sensor 15. In the present embodiment, specifically, in each original document, the topmost sheet 50 is fed first, and a next topmost sheet 50 succeeds to be fed. In S205, the counter to count a number of sheets 50 in the original document 51 having been read is increased by one, and it is examined as to whether the counter reaches to the specified number, i.e., 8.

In S205, if the counter is not reached to 8 (S205: NO), in S206, the image data obtained from the sheet 50 currently having been fed is added to the image data file for the original document 51, which is stored in the RAM 13. The process returns to S203 to examine as to whether a sheet 50 remains, and the steps S204, S205, S206 are repeated until the counter reaches to 8.

When the counter reaches to 8 (S205: YES), in S207, a terminating process for the read job for the original document 51 is executed. Specifically, the image data file for the original document 51 is completed and transmitted to be stored in a predetermined folder in the HDD of the PC 20. Thereafter, the process returns to S201, and if a remaining read job is detected (S201: YES), the process repeats S202 to create a new image data file for the next original document 52.

The steps following S202 are similarly executed for the original document 52 until a counter for the original document 52 reaches to the specified number, i.e., 7 in S205. When the counter reaches to 7 (S205: YES), in S207, the image data file for the original document 52 is completed and transmitted to the PC 20 to be stored.

The process returns to S202, and the original document 53 is processed similarly. In the original document 53, however, when image data for a lowermost sheet 50 is added to the image data file for the original document 53 (S206), no remaining sheet is detected in the automatic feeder unit 4 (S203: NO). Accordingly, in S208, the terminating process for the read job is executed.

In the above image reading device 1′, for example, the user may erroneously operate the read start button without entering the number 6 for the original document 53. In such a case, in S205 in the reading operation for the original document 52, when the counter for the original document 52 reaches to 7 (S205: YES), the read job for the original document 52 is terminated in S207, and the succeeding sheets 50 in the original document 53 are not included in the image data file for the original document 52. Thereafter, when the process returns to S201, it is judged that no read job remains (S201: NO), and the process is terminated without reading the original document 53. When, for example, the sheets 50 which are not counted in the specified numbers are included in any original document to be set in the automatic feeder unit 4, the redundant sheets 50 similarly remain unprocessed.

According to the image reading device 1′ as described above, a plurality of sets of original documents can be collectively read, and separate image data files can be created to be stored. Therefore, a plurality of sets of original documents can be efficiently read to create respective image data files.

In the above embodiment, the number “3” indicating the number of sets of the original documents 51-53 is entered through the numerical keys in the operation/display unit 5; however, the number may not necessarily be entered by the user. For example, the number of sets of the original document can be determined automatically. I.e., the user is prompted to enter a number of the sheets 50 included in each original document, and when the number for each original document is confirmed, the image reading device 1′ can judge a number of the sets based on the entered numbers. According to the example shown in FIG. 4, firstly, the user inputs 6 which indicates the number of the sheets 50 included in the original document 53 through the numerical key. When the number 6 is entered, the image reading device 1′ waits for another number indicating the number of the sheets 50 included in the original document 52, i.e., 7. When the user inputs 7, and when the number is entered, the user can operate the read start button to start the reading operations for the original documents 53, 52. It is to be noted that the numbers are entered twice; therefore, it is determined that the number of sets of original documents to be read is two.

In the above configuration, if the image reading device 1′ is configured to accept additional input of a number of sheets 50 included in an additional original document 51, the original document 51 can be added on top of the original document 52 to be read collectively.

Therefore, when a succeeding user being different from the user who operated the image reading device 1′ to create the image data files for the original documents 51, 52 comes to the image reading device 1′ to create an image data file for the original document 53, the succeeding user can place the original document 53 on top of the original document 52 and enter 8 indicating the number of the sheets 50 included in the original document 53. Thus, the image reading operation for the original document 53 can be executed successively after the reading operation to read the original document 52 is completed. It is to be noted that the numbers respectively indicating the number of sheets 50 in each original document are entered three times; therefore, it is determined that the number of sets of original documents to be read is three.

In the above configuration, it is required that the sheets 50 set in the automatic feeder unit 4 are fed in an order from bottom to top. I.e., the lowermost sheet 50 in the original document 53 is fed first, and a next lowermost sheet 50 succeeds to be fed. Further, when the reading operation for the original document 53 is completed, next, a lowermost sheet 50 in the original document 52 is fed, and the feeding continues in the bottom-to-top order. With this configuration, the succeeding user can set the additional original document to be read without waiting for the completion of the preceding reading operation.

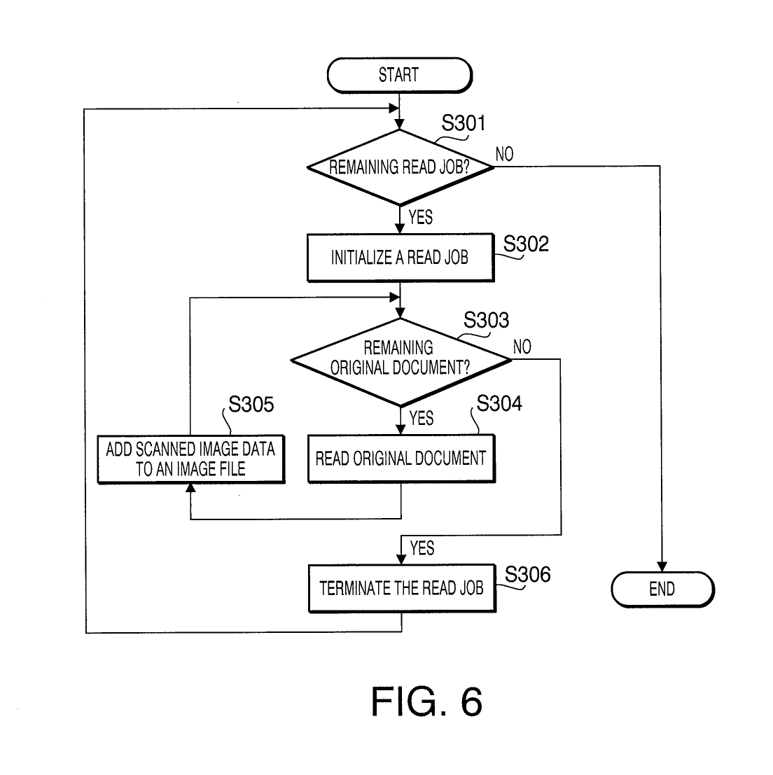

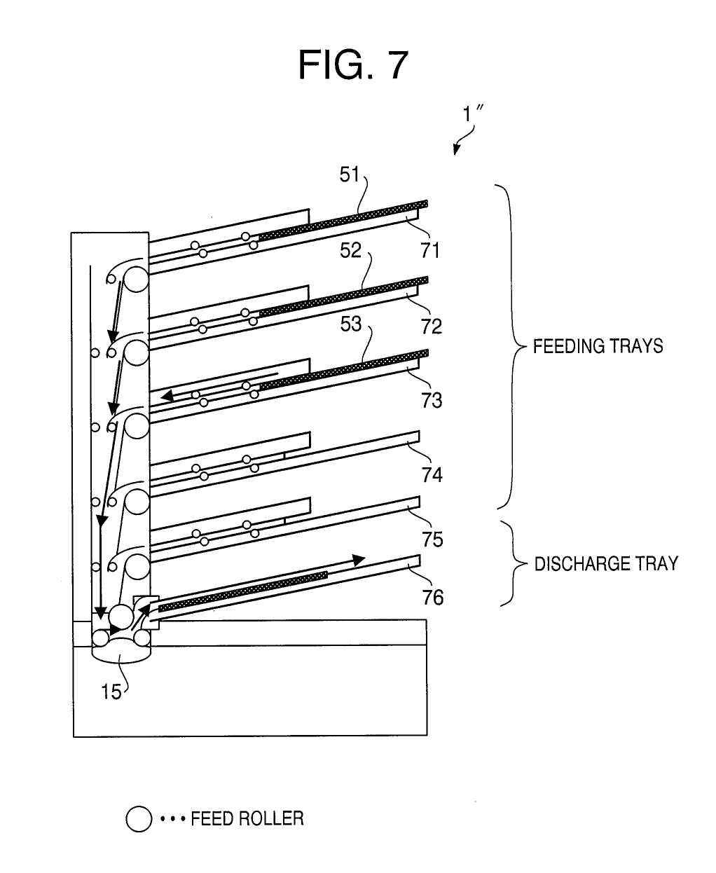

Next, a third embodiment according to the present invention will be described with reference to FIGS. 6 and 7. FIG. 6 is a flowchart to illustrate an image reading operation according to the third embodiment of the present invention. FIG. 7 is a diagram to schematically illustrate an image reading device 1″ with a plurality of feeding trays and a discharge tray according to the third embodiment of the present invention. Specifically, the image reading device 1″ is provided with five feeding trays, which are first, second, third, fourth, and fifth feeding trays 71, 72, 73, 74, 75 Therefore, the user can set each of the original documents 51-53 in one of the five feeding trays 71, 72, 73, 74, 75 for the reading operations. In the present embodiment, for example, the original documents 51, 52, 53 are set in the first feeding tray 71, the second feeding tray 72, and the third feeding tray 73 respectively. The fourth and fifth feeding trays 74, 75 are unloaded. The image reading device 1″ is further provided with a discharge tray 76.

When the read start button is operated, the image reading operation starts in the image reading device 1″. In S301, it is examined as to whether a read job remains unprocessed. Specifically, in the present embodiment, when an original document is placed in any of the feeding trays 71, 72, 73, 74, 75, it is judged that a read job remains (S301: YES). In S302, the read job is initialized.

In S303, it is examined as to whether at least one sheet 50 of the original document 51 is placed in the first feeding tray. If a sheet 50 is detected (S303: YES), in S304, the automatic feeder unit 4 feeds the sheets 50 in the first feeding tray 71 one by one, and each sheet 50 is read by the image sensor 15.

In S305, the image data obtained by the image sensor 15 is added to an image data file for the original document 51, which is stored in the RAM 13. The process returns to S303 to examine as to whether a sheet 50 remains, and the steps S304, S305 are repeated until the entire sheets 50 in the original document 51 are read.

In S303, if no sheet 50 is detected (S303: NO), in S306, the image data file for the original document 51 is completed and transmitted to be stored in a predetermined folder in the HDD of the PC 20. Thereafter, the process returns to S301, and if a remaining read job is detected (S301: YES), the process repeats S302 to create a new image data file for the next original document 52.

The steps following S302 are similarly executed for the original document 52 until the entire sheets 50 in the original document 52 set in the second feeding tray 72 are read. When no sheet 50 is detected in the second feeding tray 72 (S303: NO), in S306, the image data file for the original document 52 is completed and transmitted to the PC 20 to be stored. The process returns to S302, and the original document 53 is processed similarly until the entire sheets 50 in the original document 53 set in the third feeding tray 73 are read. The process returns to S301, and when no remaining read job is detected in any of the remaining feeding trays 74, 75 (S301: NO), the process is terminated.

According to the image reading device 1″ in the above embodiment, a plurality of sets of the original documents 51-53 can be collectively read, and an image data file for each original document can be created even during a preceding reading operation. Therefore, succeeding users may not be required to wait for the image reading device 1″ to finish reading an original document of the preceding user so that the image reading operations for the plurality of sets of original documents can be executed efficiently.

The above embodiment can be applied to an image reading device having a job reservation function, which is disclosed, for example, in Japanese Patent Provisional Publication No. 2000-238952, the entire disclosure of which is incorporated herein by reference. According to the disclosure in the above-referenced publication, the image reading device is provided with a plurality of feeding trays so that a plurality of sets of original documents can be arranged in the respective feeding trays. The plurality of sets of original documents are read sequentially according to a reserved reading order and discharged in corresponding discharge trays respectively.

In the above publication, however, the plurality of sets of original documents are required to be set initially in the respective feeding trays before the first set of original documents is read, an operation of the image reading device to process an additional set of original documents, when the additional set of original documents is set in an unloaded feeding tray during a preceding reading operation of the initially set original documents, is not disclosed. Specifically, sequential reading operations for a plurality of users are not disclosed. Further, in addition to a plurality of discharge trays, a sorting mechanism to sort the plurality of sets of the original documents having been read in the corresponding discharge trays is required. Thus, the configuration of the image reading device becomes complicated.

However, in the present embodiment, the image reading device 1″ requires solely one discharge tray 76; therefore, a sorting mechanism can be omitted, and the entire configuration of the image reading device 1″ can be less complicated. Additionally, because the plurality of sets of the original documents 51-53 are stacked collectively in the discharge tray 76, when the plurality of sets of the original documents 51-53 are no longer required to be kept in paper after creation of the corresponding electric image data files, the stack of original documents 51-53 can be collectively picked up to be discarded.

Although examples of carrying out the invention has been described, those skilled in the art will appreciate that there are numerous variations and permutations of the image reading device that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, the image reading device shown in FIG. 1 may be equipped to a multifunction peripheral device having additional functions as long as the device includes the automatic feeder unit. For another example, a configuration to separate the original documents may not be limited to the separating sheet or the number of the sheets included in the original documents.

What is claimed is:

1. An image reading device, comprising:
an automatic feeder unit to feed original sheets one by one;
an image reading unit to read an image formed on each of the original sheets being fed; and
a file creation unit to create a data file for a set of the image read by the image reading unit and store the created data file in a predetermined storage unit,
wherein, when a plurality of sheet sets, respectively including at least one original sheet, are placed in the automatic feeder unit to be fed successively and when a criterial feature to distinguish a current sheet set from a succeeding sheet set is detected between two successive sheet sets, the file creation unit completes the data file for the image which has been read from the current sheet set by the image reading unit and starts creating a new data file for the succeeding sheet set.

2. The image reading device according to claim 1,
wherein the criterial feature is a sheet in a predetermined format, which is set between the two successive sheet sets and read by the image reading unit to distinguish the two successive sheet sets.

3. The image reading device according to claim 1, further comprising:
an operation unit through which numerical information can be entered; and
a counter to count a number of the at least one original sheet in each sheet set which has been read by the image reading unit,
wherein a number of original sheet to be read included in each sheet set is specified by a user through the operation unit; and
wherein the file creation unit completes the data file for the image which has been read from the current sheet set when the counter for the current sheet set is increased to the specified number.

4. The image reading device according to claim 3,
wherein a number of sheet sets to be read is specified through the operation unit; and
wherein the file creation unit repeats creating the data file for a number of times, which corresponds to the specified number of sheet sets.

5. The image reading device according to claim 1,
wherein the automatic feeder unit is provided with a plurality of feeding trays;
wherein each of the sheet sets is placed in one of the plurality of feeding trays;
wherein the original sheets in the respective sheet sets are successively fed by the automatic feeder unit; and
wherein the file creation unit creates the data file when the at least one original sheet in one of the sheet sets placed in one of the feeding trays is entirely read by the image reading unit.
